(19) United States
(12) Patent Application Publication
(10) Pub. No.: US 2017/0262538 A1
(43) Pub. Date: Sep. 14, 2017

(54) METHOD OF AND SYSTEM FOR GROUPING OBJECT IN A STORAGE DEVICE

(71) Applicant: YANDEX EUROPE AG, Luzern (CH)

(72) Inventor: Vladimir Alexandrovich RUSINOV, Moscow (RU)

(21) Appl. No.: 15/529,113

(22) PCT Filed: May 28, 2015
(86) PCT No.: PCT/IB2015/054016

§ 371 Date: May 24, 2017

(30) Foreign Application Priority Data
Nov. 28, 2014 (RU) 2014147906

(51) Int. Cl. G06F 17/30

(52) U.S. Cl. CPC G06F 17/30749; G06F 17/30917; G06F 17/30775

(57) ABSTRACT

There is disclosed a method of organising objects stored on a server. The method comprises: receiving a first clustering request for a first metadata mapping; based at least in part on the metadata, generating the first metadata mapping of the first subset of objects to the first cluster, the first metadata mapping not being in existence prior to said receiving; receiving, via the communication network, from the electronic device an indication of a user action with the first subset of objects being displayed on the electronic device, the user action causing a change from the first subset of objects into a second subset of objects; based at least on the metadata associated with the second subset of objects, generating a second metadata mapping of the second subset of the objects to a second cluster, the second metadata mapping not being in existence prior to said receiving.

### CROSS-REFERENCE

The present application claims priority to Russian Patent Application No. 2014147906, filed Nov. 28, 2014, entitled “METHOD OF AND SYSTEM FOR GROUPING OBJECT IN A STORAGE DEVICE” the entirety of which is incorporated herein.

### FIELD OF THE TECHNOLOGY

The present technology relates to electronic communications over a communication network in general and, specifically, to a method of and a system for grouping objects in a storage device.

### BACKGROUND

A typical electronic device, be it a laptop, a desktop or a smartphone, allows the user associated therewith to perform a plethora of functions. For example, a typical user of one of electronic devices provided by Apple Corporation of 1 Infinite Loop, Cupertino, Calif., United States of America (such as the iPhone™ and the iPad™ device), can perform a number of functions using such the electronic device. These functions include, just to name a few, sending and receiving e-mail messages, sending and receiving short text messages (such as iMessages™ or text messages), listening to audio files, watching video files; taking, storing and sharing photos and videos; using one of a plethora of applications available from the so-called Apple.Store™—a repository of applications specifically developed for such electronic devices.

Even though the capacity of the storage devices (such as hard drives of such electronic devices or external memory devices connected to such electronic devices) has significantly increased, while the cost has significantly decreased, in the recent years, the electronic devices still have finite memory.

For example, the iPhone5™ smartphone was available with the hard drive memory capacity of 8 GB, 16 GB, 32 GB, 64 GB and 128 GB. Naturally, stationary electronic devices (such as desktops and, to a lesser extent, laptop computers) are associated with higher, yet also finite, memory storage capacity.

The typical user these days stores large amount of data on their electronic devices. This data includes, but is not limited to, documents, audio files, video files, photo images and the like. In order to either conserve the local memory space or as means for backing up data, it is known for users to upload some or all of the data maintained on the electronic devices (such as photos, videos, document files, and the like) to a cloud-based storage account (such services are provided by DropBox™ storage service, JustCloud™ storage service, Yandex.Disk™ cloud service and the like).

Whether the volume of data is stored locally on the electronic device or in the cloud, a typical user is faced with a problem of having to go through the volume of information to locate the one data object that the user is looking for at the particular moment in time. Several solutions to such a problem have been proposed in the prior art.

For example, with audio files, it is known to organize the audio files into playlists and the like. By the same token, it is known to organize photos according to albums or ‘moments’.

US 2011/0060738 published on Mar. 10, 2011 to Gates et al teaches methods and arrangements for facilitating generation of media mixes for a program participant based at least in part on media library inventory information provided by a number of program participants. Those individuals that decide to be program participants are interested in organizing, maintaining and playing their music, based at least in part, on data derived from a population of other participants in the program. A program participant must send, and the system, receive, data representative of that program participant's media inventory. The system or program determines a relative similarity of each item from the collection of program participants as compared to each other item and from the similarity information clusters of similar items are identified. The clusters can be used to identify clusters of similar items in an individual program participant's media library and therefrom mixes of similar media items can be created.

US 2014/0040262 published on Feb. 6, 2014 to Winter et al discloses techniques for facilitating a similarity search of digital assets (e.g., audio files, image files, video files, etc.). Consistent with some embodiments, a cloud-based search service manages one or more search tree data structures for use in organizing digital assets to make the digital assets searchable. Each digital asset is associated with a feature vector based on the various attributes and/or characteristics of the digital asset. The digital assets are then assigned to leaf nodes in one or more search tree data structures based on a measure of the distance between the feature vector of the digital asset and a virtual feature vector associated with a leaf node. When a search for similar digital assets is invoked, a prioritized breadth first search of a search tree is performed to identify the digital assets having the feature vectors closest in distance to the reference digital asset.

US 2014/0250126 published on Sep. 4, 2014 to Baldwin et al discloses a method that includes automatically and without user input grouping one or more images captured by a first user into clusters of particular moments based at least in part on metadata associated with one or more of the images or data determined through analysis of one or more of the images. Each particular moment being associated with a particular geo-location and time. The method also includes, for each of one or more of the clusters, determining curating information corresponding to the cluster based at least in part on the metadata associated with images in the cluster, the data determined through analysis of images in the cluster, or social-graph information associated with images in the cluster; and providing the clusters of images and at least some of the curating information corresponding to them for display on a computing device of the first user.

### SUMMARY

It is thus an object of the present technology to ameliorate at least some of the inconveniences present in the prior art.

Embodiments of the present technology have been developed based on developer(s) realization of at least one technical problem associated with the prior art solution. Take an example with the prior art solution to clustering audio files into some sort of clusters, for example, based on the album or the singer. The clustering is typically performed on the electronic device and is extremely computational-resources consuming. As such, when the user, as an example, downloads the audio library to the electronic device and requests the clustering, the process of clustering takes significant strain on the computational resources of the electronic device. This, in turn, can lead to a significant battery drain, especially, in case where the electronic device is implemented as a wireless communication device (such as a smartphone and the like). Additionally, the execution of the clustering process on the electronic device can cause a delay in the objects being clustered being displayed to the user, hence potentially leading to user dis-satisfaction with the functionality of the electronic device.

As such, according to a first broad aspect of the present technology, there is provided a method of organising objects stored, in association with a user, on a server. The method is executable on the server, the server being coupled to a communication network. The method comprises: receiving, via the communication network, from an electronic device associated with the user, a first clustering request for a first metadata mapping of a first subset of objects into at least a first cluster; acquiring metadata associated with each of the first subset of objects; based at least in part on the metadata, generating the first metadata mapping of the first subset of objects to the at least the first cluster; transmitting, via the communication network, the first metadata mapping to the electronic device, the first metadata mapping for allowing the electronic device to display the first subset of objects organized into the at least the first cluster; receiving, via the communication network, from the electronic device an indication of a user action with the first subset of objects being displayed on the electronic device, the user action causing a change from the first subset of objects into a second subset of objects; acquiring metadata associated with each of the second subset of objects; based at least on the metadata associated with the second subset of objects, generating a second metadata mapping of the second subset of the objects to at least a second cluster, and transmitting the second metadata mapping to the electronic device, the second metadata mapping for allowing the electronic device to display the second subset of objects organized in the at least the second cluster.

In some implementations of the method, the user action is deletion of an object from the first subset of objects to create the second sub-set of objects.

In some implementations of the method, the step of generating the second metadata mapping further comprises determining if any additional objects need to be added to the second sub-set of objects to create the second cluster.

In some implementations of the method, the step of generating the second metadata mapping further comprises determining if the at least one cluster need to be deleted.

In some implementations of the method, the user action is an addition of a new object to the first subset of objects to create the second sub-set of objects.

In some implementations of the method, the method further comprises determining if responsive to the addition of the new object, the first cluster needs to be re-organized into the second cluster and a third cluster, the second cluster and the third cluster being part of at least the second cluster.

In some implementations of the method, responsive to the determining rendering a positive outcome, the step of generating a second metadata mapping comprises: generating the second metadata mapping of a first portion of the second subset of the objects to the second cluster; and generating a third mapping of a second portion of the second subset of the objects to the second cluster.

In some implementations of the method, the user action is a scroll action, and the first sub-set of objects corresponds to a paging resolution of the display of the electronic device, and the step of generating a second metadata mapping comprises: based on the scroll action, determining an offset between the first subset of objects and the second subset of objects; and creating the second subset of objects organized in the at least the second cluster using the offset from a last object in the first sub-set.

In some implementations of the method, the at least first cluster is a grouping of objects in a first period of time of creation of objects and the at least second cluster is a grouping of objects in a second period of time of creation of objects, and the user action is indicative of the user desire to switch from the first period to the second period; and the step of generating a second metadata mapping comprises: based on the user action, determining a time offset between the first period and the second period; and creating the second subset of objects organized in the at least the second cluster using the time offset from an end of the first period.

In some implementations of the method, the objects comprise photos and metadata includes at least one of: (i) an indication of a geo-location where the respective image was generated, (ii) an indication of a time when the respective image was generated; (iii) an indication of one or more individuals captured within the respective photos.

In some implementations of the method, the objects comprise audio files and metadata includes at least one of: (i) an indication of an artist associated with the audio track, (ii) an indication of a title associated with the audio file, (iii) an indication of an album associated with the audio track and (iv) a duration of the audio file.

In some implementations of the method, the step of generating a second metadata mapping of the second subset of the objects to at least a second cluster further comprises analyzing metadata of all objects to create the second cluster.

In some implementations of the method, the electronic device is a wireless electronic device, and the step of transmitting the second metadata mapping to the electronic device further causes the electronic device to update the first metadata mapping with changes based on analysis of the second metadata mapping.

In some implementations of the method, the electronic device is a stationary computing device, and the step of transmitting the second metadata mapping to the electronic device further causes the electronic device to replace the first metadata mapping with the second metadata mapping.

In some implementations of the method, the electronic device is a first electronic device and the step of transmitting, via the communication network, the first metadata mapping comprises transmitting the first metadata mapping to the first electronic device and a second electronic device, the first metadata mapping for allowing both the first electronic device and the second electronic device to display the first subset of objects organized into the at least the first cluster.

In some implementations of the method, the electronic device is a first electronic device and the step of transmitting, via the communication network, the second metadata mapping comprises transmitting the second metadata mapping to the first electronic device and a second electronic device, the second metadata mapping for allowing both the first electronic device and the second electronic device to display the second subset of objects organized into the at least the second cluster.

In some implementations of the method, the step of transmitting, via the communication network, the first metadata mapping to the electronic device further comprises transmitting an indication of each of the objects within the first subset of the objects.

In some implementations of the method, the step of transmitting, via the communication network, the second metadata mapping to the electronic device further comprises transmitting an indication of each of the objects within the second subset of the objects.

In some implementations of the method, the step of transmitting, via the communication network, the second metadata mapping to the electronic device further comprises transmitting an indication of only those of the second subset that have changed compared to the first subset of objects.

In accordance with another broad aspect of the present technology there is provided a server. The server comprises: a communication interface for communication with an electronic device via a communication network, a memory storage; a processor operationally connected with the communication interface and the memory storage, the processor configured to store objects, in association with a user, on the memory storage, the processor being further configures to: receive, via the communication interface, from an electronic device associated with the user, a first clustering request for a first metadata mapping of a first subset of objects into at least a first cluster; acquire, from the memory storage, metadata associated with each of the first subset of objects; based at least in part on the metadata, generate the first metadata mapping of the first subset of objects to the at least the first cluster; transmit, via the communication interface, the first metadata mapping to the electronic device, the first metadata mapping for allowing the electronic device to display the first subset of objects organized into the at least the first cluster; receive, via the communication interface, from the electronic device an indication of a user action with the first subset of objects being displayed on the electronic device, the user action causing a change from the first subset of objects into a second subset of objects; acquire, from the memory storage, metadata associated with each of the second subset of objects; based at least on the metadata associated with the second subset of objects, generate a second metadata mapping of the second subset of the objects to at least a second cluster, and transmit the second metadata mapping to the electronic device, the second metadata mapping for allowing the electronic device to display the second subset of objects organized in the at least the second cluster.

In some implementations of the server, the user action is deletion of an object from the first subset of objects to create the second sub-set of objects.

In some implementations of the server, to generate the second metadata mapping, the processor is configured to determine if any additional objects need to be added to the second sub-set of objects to create the second cluster.

In some implementations of the server, to generate the second metadata mapping, the processor is configured to determine if the at least one cluster need to be deleted.

In some implementations of the server, the user action is an addition of a new object to the first subset of objects to create the second sub-set of objects.

In some implementations of the server, the processor being further configured to determine if responsive to the addition of the new object, the first cluster needs to be re-organized into the second cluster and a third cluster, the second cluster and the third cluster being part of at least the second cluster.

In some implementations of the server, responsive to the determining rendering a positive outcome and to generate the second metadata mapping, the processor is configured to: generate the second metadata mapping of a first portion of the second subset of the objects to the second cluster; and generate a third mapping of a second portion of the second subset of the objects to the second cluster.

In some implementations of the server, the user action is a scroll action, the first sub-set of objects corresponds to a paging resolution of the display of the electronic device, and to generate the second metadata mapping, the processor is configured to: based on the scroll action, determine an offset between the first subset of objects and the second subset of objects; and create the second subset of objects organized in the at least the second cluster using the offset from a last object in the first sub-set.

In some implementations of the server, the at least first cluster is a grouping of objects in a first period of time of creation of objects and the at least second cluster is a grouping of objects in a second period of time of creation of objects, and the user action is indicative of the user desire to switch from the first period to the second period; and to generate the second metadata mapping, the processor is configured to: based on the user action, determine a time offset between the first period and the second period; and create the second subset of objects organized in the at least the second cluster using the time offset from an end of the first period.

In some implementations of the server, the objects comprise photos and metadata includes at least one of: (i) an indication of a geo-location where the respective image was generated, (ii) an indication of a time when the respective image was generated; (iii) an indication of one or more individuals captured within the respective photos.

In some implementations of the server, the objects comprise audio files and metadata includes at least one of: (i) an indication of an artist associated with the audio track, (ii) an indication of a title associated with the audio file, (iii) an indication of an album associated with the audio track and (iv) a duration of the audio file.

In some implementations of the server, to generate the second metadata mapping of the second subset of the objects to at least the second cluster, the processor is further operable to analyze metadata of all objects to create the second cluster.

In some implementations of the server, the electronic device is a wireless electronic device, and the transmitting the second metadata mapping to the electronic device further causes the electronic device to update the first metadata mapping with changes based on analysis of the second metadata mapping.

In some implementations of the server, the electronic device is a stationary computing device, and the transmitting the second metadata mapping to the electronic device further causes the electronic device to replace the first metadata mapping with the second metadata mapping.

In some implementations of the server, the electronic device is a first electronic device and to transmit, via the communication network, the first metadata mapping, the processor is configured to transmit the first metadata mapping to the first electronic device and a second electronic device, the first metadata mapping for allowing both the first electronic device and the second electronic device to display the first subset of objects organized into the at least the first cluster.

In some implementations of the server, the electronic device is a first electronic device and to transmit, via the communication network, the second metadata mapping, the processor is configured to transmit the second metadata mapping to the first electronic device and a second electronic device, the second metadata mapping for allowing both the first electronic device and the second electronic device to display the second subset of objects organized into the at least the second cluster.

In some implementations of the server, to transmit, via the communication network, the first metadata mapping to the electronic device, the processor is further configured to transmit an indication of each of the objects within the first subset of the objects.

In some implementations of the server, to transmit, via the communication network, the second metadata mapping to the electronic device, the processor is further configured to transmit an indication of each of the objects within the second subset of the objects.

In some implementations of the server, to transmit, via the communication network, the second metadata mapping to the electronic device, the processor is further configured to transmit an indication of only those of the second subset that have changed compared to the first subset of objects.

In the context of the present specification, unless specifically provided otherwise, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, unless specifically provided otherwise, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, unless specifically provided otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, unless specifically provided otherwise, the expression “information” includes information of any nature or kind whatsoever capable of being stored in a database. Thus information includes, but is not limited to audiovisual works (photos, movies, sound records, presentations etc.), data (location data, numerical data, etc.), text (opinions, comments, questions, messages, etc.), documents, spreadsheets, etc.

In the context of the present specification, unless specifically provided otherwise, the expression “component” is meant to include software (appropriate to a particular hardware context) that is both necessary and sufficient to achieve the specific function(s) being referenced.

In the context of the present specification, unless specifically provided otherwise, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, unless specifically provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, unless specifically provided otherwise, the word “photo” has been used to denote a file containing a digital image data, such as data associated with a captured photograph and the like. An image file format is not particularly limited and in the various embodiments of the present technology, the image file of the photo may store data in uncompressed, compressed, or vector formats. The type of the file is not particular limited and can include a raw file format, JPEG, GIF, TIFF and the like.

In the context of the present specification, unless specifically provided otherwise, the word “cluster” has been used to denote a sub-set of objects (such as photos, but not limited thereto), virtually organized based on their relative metadata. The process of organizing of objects into the clusters can be referred to as clustering. Within the embodiments of the present technology, the clusters are event-based, the event being determined based on metadata of the objects. Some examples of various clusters that can be used for photos (photos being just one example of the objects) include: date, place of image capture, both date and place of image capture and the like.

In the context of the present specification, unless specifically provided otherwise, the word “period” has been used to denote a specific time interval, which can be, for example, a day, a month, a year and the like.

In the context of the present specification, unless specifically provided otherwise, the word “geo-location” or, simply, “location” has been used to denote a human-understandable location where a given photo has been captured. The geo-location can be based on location-associated metadata of the photo. In some embodiments, the geo-location is generated by converting geo-coordinates of the photo into the human-understandable location.

In the context of the present specification, unless specifically provided otherwise, the word “storage version” has been used to denote an indication of the current state of the storage, the current state of the version being expressed as the Unix time (a.k.a. POSIX time or Epoch time), which is a description of an instant in time, defined as the number of seconds that have elapsed since 00:00:00 Coordinated Universal Time (UTC), Thursday, 1 Jan. 1970. Within embodiments of the present technology, the Unix time can be represented with precision to the sixths decimal point.

In the context of the present specification, unless specifically provided otherwise, the word “clustering policy version” has been used to denote an indication of the version of the clustering policy used, which indication can be expressed as a sequential numeral, a sequential letter or a combination of any alpha-numeric symbols.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram of a system implemented in accordance with an embodiment of the present technology.

FIG. 2 depicts a non-limiting example of a metadata mapping maintained in association with objects uploaded by a user to the remote storage server of the system of FIG. 1.

FIG. 3 depicts a flow-chart of a method, the method being implemented in accordance with non-limiting embodiments of the present technology and being executable on the remote storage server of the system of FIG. 1.

### DETAILED DESCRIPTION

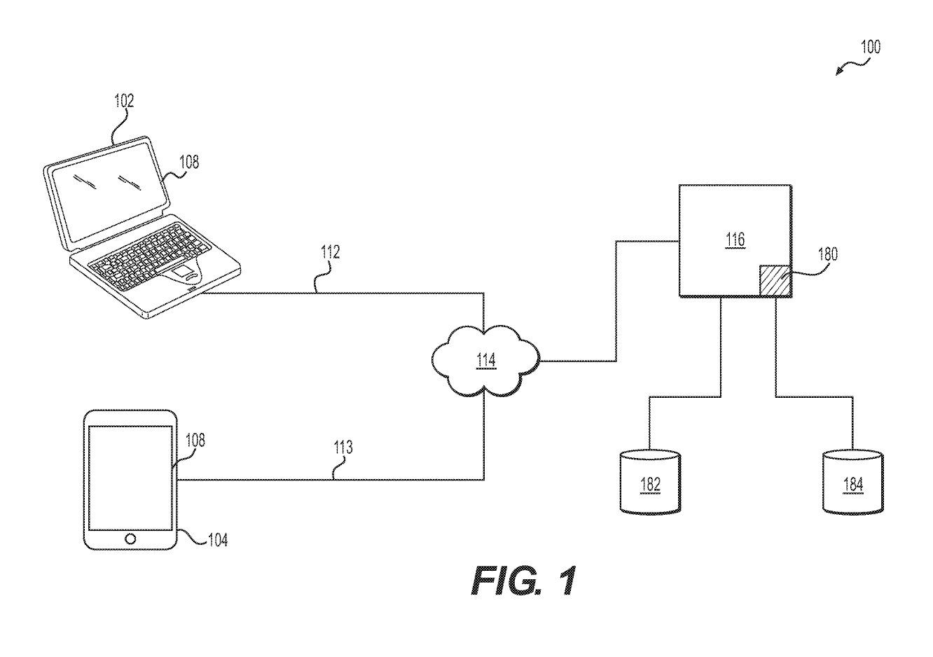

Referring to FIG. 1, there is shown a diagram of a system 100, the system 100 being suitable for implementing non-limiting embodiments of the present technology. It is to be expressly understood that the system 100 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The system 100 comprises a first electronic device 102. The first electronic device 102 is typically associated with a user (not depicted) and, as such, can sometimes be referred to as a “client device”. It should be noted that the fact that the first electronic device 102 is associated with the user does not need to suggest or imply any mode of operation—such as a need to log in, a need to be registered or the like.

The implementation of the first electronic device 102 is not particularly limited, but as an example, the first electronic device 102 may be implemented as a personal computer (desktops, laptops, netbooks, etc.), a wireless electronic device (a cell phone, a smartphone, a tablet and the like), as well as network equipment (a router, a switch, or a gateway). Merely for the purposes of an illustration, it shall be assumed that the first electronic device 102 is implemented as a laptop computer, such as LENOVO™ THINKPAD™ X220 lap top running a WINDOWS™ operating system.

The first electronic device 102 comprises hardware and/or software and/or firmware (or a combination thereof) to execute a number of applications. For the purposes of illustration of the embodiments of the present technology, it shall be assumed that the first electronic device 102 is configured to the execute a photo application 108. Generally speaking, the purpose of the photo application 108 is to enable the user (not depicted) to (i) capture one or more photos or videos using a built-in camera (not separately depicted) of the first electronic device 102; (ii) to store and organize the so-captured photos or videos, (iii) manipulate the so captured photos or videos, (iv) share the so-captured photos or videos with other users by means of e-mail, text messages or social media applications, and (v) perform a number of additional functions known to those of skill in the art. The photo application 108 can be “native” to the operating system of the first electronic device 102 (i.e. being provided as part of the operating system package) or can be downloaded and installed by the user of the first electronic device 102. It should be expressly understood that teachings of the present technology are not limited to the photo applications and photos being objects to be clustered and, as such, can be applied to other types of applications executed on the first electronic device 102.

The system 100 comprises a second electronic device 104. The second electronic device 104 is also associated with the same user as the first electronic device 102. The implementation of the second electronic device 104 is also not particularly limited, but as an example, the second electronic device 104 may be implemented as a personal computer (desktops, laptops, netbooks, etc.), a wireless electronic device (a cell phone, a smartphone, a tablet and the like), as well as network equipment (a router, a switch, or a gateway). Merely for the purposes of an illustration, it shall be assumed that the second electronic device 104 is implemented as a smartphone computer, such as iPhone 5™ smartphone provided by Apple Corporation.

The second electronic device 104 also comprises hardware and/or software and/or firmware (or a combination thereof) to execute the photo application 108.

Both of the first electronic device 102 and the second electronic device 104 are communicatively coupled to a communication network 114 via a respective instance of a communication link—namely, a first communication link 112 and a second communication 113.

In some non-limiting embodiments of the present technology, the communication network 114 can be implemented as the Internet. In other embodiments of the present technology, the communication network 114 can be implemented differently, such as any wide-area communication network, local-area communication network, a private communication network and the like.

How the first communication link 112 and the second communication link 113 are implemented is not particularly limited and will depend on how the associated one of the first electronic device 102 and the second electronic device 104 is implemented.

Recalling that the first electronic device 102 can be implemented, in this example, as a laptop, the first communication link 112 can be wireless (such as the Wireless Fidelity, or

WiFi® for short, Bluetooth® or the like) or wired (such as Ethernet™ based connection). Recalling that the second electronic device 104 can be implemented, in this example, as a smartphone, the second communication link 113 can be wireless—such as the Wireless Fidelity, or WiFi® for short, Bluetooth® or the like or cellular (such as 3G, LTE and the like).

It should be expressly understood that implementations for the first electronic device 102, the second electronic device 104, the first communication link 112, the second communication link 113, and the communication network 114 are provided for illustration purposes only. As such, those skilled in the art will easily appreciate other specific implementational details for the first electronic device 102, the second electronic device 104, the first communication link 112, the second communication link 113, and the communication network 114. As such, by no means, examples provided herein above are meant to limit the scope of the present technology.

Within embodiments of the present technology, there is also provided a remote storage server 116 (also, referred to for simplicity as the “server 116”). The remote storage server 116 can be implemented as a conventional computer server. In an example of an embodiment of the present technology, the remote storage server 116 can be implemented as a Dell™ PowerEdge™ Server running the Microsoft™ Windows Server™ operating system. Needless to say, the remote storage server 116 can be implemented in any other suitable hardware and/or software and/or firmware or a combination thereof. In the depicted non-limiting embodiment of present technology, the remote storage server 116 is a single server. In alternative non-limiting embodiments of the present technology, the functionality of the remote storage server 116 may be distributed and may be implemented via multiple servers.

The remote storage server 116 comprises hardware and/or software and/or firmware (or a combination thereof) to execute a remote storage application 180. The remote storage application 180 can also be referred to by those of skill in the art as a remote storage or a cloud storage.

The general implementations of the remote storage application 180 are known and, as such, will not be described here at much length. Suffice it to state that the remote storage server 116 can execute or have access to a memory storage 182, the memory storage 182 can be implemented as conventional storage device, such as one or more disk storage devices.

The remote storage application 180 is configured to maintain one or more accounts associated with one or more users, such as the user of the first electronic device 102 and the second electronic device 104. Such the user of the remote storage application 180 can be thought of as a “subscriber” to the remote storage service provided by the remote storage application 180. Generally speaking, the term “subscriber” should not be interpreted to have any particular meaning and, as such, teachings of the present technology equally apply to both “free” and “paid for” remote storage services.

According to embodiments of the present technology, the remote storage application 180 is configured to (i) maintain a storage portion (i.e a portion of a memory dedicated to) associated with the subscriber; (ii) receive one or more objects to be stored in the storage portion associated with the subscriber; (iii) cluster one or more objects stored within the storage portion into one or more clusters to create a mapping between a given one of the one or more objects with the associated cluster; (iv) transmit to the subscriber's electronic device (such as the first electronic device 102 and/or the second electronic device 104) an indication of the metadata mapping and/or the objects for displaying to the user of the objects organized into clusters.

To that end, the remote storage server 116 can be configured to execute or have access to a control module 184. The control module 184, broadly speaking, is configured to execute the functions of: (i) a back-end processing module, (ii) a front-end rendering module and (iii) a clustering module. Together, the functionality of the control module 184, combined with the functionality of the memory storage 182, is configured to support the execution of the remote storage application 180.

For the purposes of the illustrations to be presented herein below, the following example scenario will be used. Let it be assumed that a “User A” is associated with the first electronic device 102 and the second electronic device 104. Is shall be further assumed that the User A is a subscriber to the remote storage service provided by the remote storage server 116. Naturally, a typical user may have more or fewer objects stored at the remote storage server 116.

It shall be further assumed that the User A has uploaded 40 photos to the user-account stored at the remote storage server 116. Each of the 40 photos has the associated metadata indicative of the date when the photo was taken and of a geo-location of where the photo was taken.

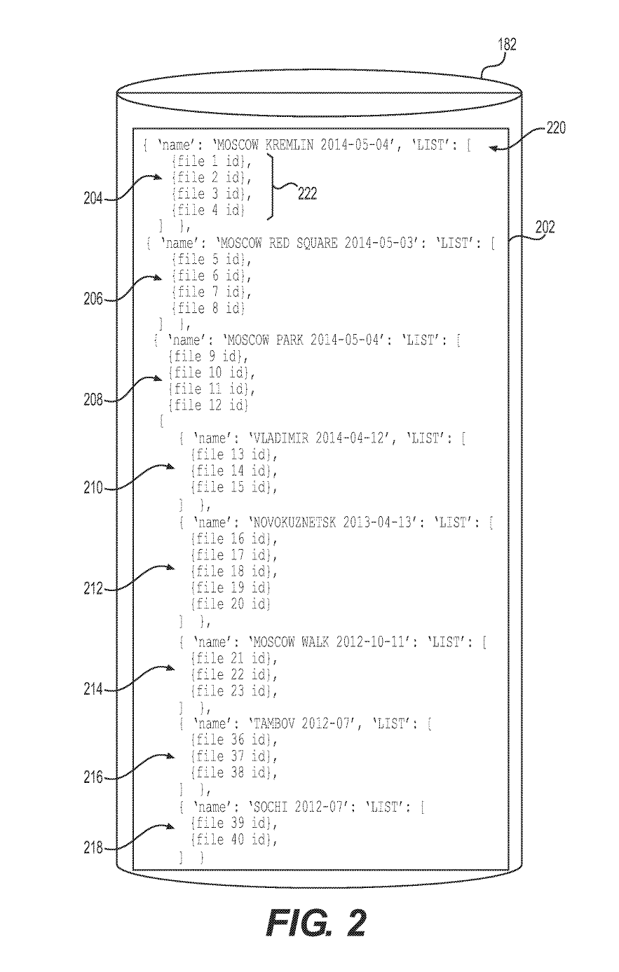

With reference to FIG. 2, there is depicted a non-limiting example of a metadata mapping 202 created and maintained in association with objects uploaded by the User A at the remote storage server 116. The metadata mapping 202 maintains a mapping of each of the 40 photos stored on the remote storage server 116 to an associated cluster. More specifically, within the illustration of FIG. 2, the remote storage server 116 has organized the 40 photos associated with the User A into eight clusters, the clustering having been done based on the metadata associated with each of the 40 photo. Within the illustrated embodiment, the metadata used for clustering comprises the place and the date of the capturing of the respective photo. However, in alternative embodiments, the clustering can be done on the basis of a sub-set of these metadata parameters or even completely different metadata parameters.

Within the embodiments of the present technology, the metadata associated with the photos can be stored within the memory storage 182. In alternative embodiments of the present technology, the metadata associated with the photos can be stored in a separate memory storage (not depicted).

Within the illustration of the metadata mapping 202, there are provided eight clusters, as has been mentioned above, a first cluster 204, a second cluster 206, a third cluster 208, a fourth cluster 210, a fifth cluster 212, a sixth cluster 214, a seventh cluster 216 and an eighth cluster 218. Each of the clusters (the first cluster 204, the second cluster 206, the third cluster 208, the fourth cluster 210, the fifth cluster 212, the sixth cluster 214, the seventh cluster 216 and the eighth cluster 218) is associated with the objects that have metadata that match the metadata parameters used to create the respective cluster (the first cluster 204, the second cluster 206, the third cluster 208, the fourth cluster 210, the fifth cluster 212, the sixth cluster 214, the seventh cluster 216 and the eighth cluster 218), based on the associated version of a clustering policy.

Each of the clusters (the first cluster 204, the second cluster 206, the third cluster 208, the fourth cluster 210, the fifth cluster 212, the sixth cluster 214, the seventh cluster 216 and the eighth cluster 218) comprises an indication of a cluster title 220 and an indication of the one or more cluster members 222. The cluster title 220 can be based on the metadata that was used for generating the respective cluster. As such, the cluster title 220 associated with the first cluster 204 comprises “Moscow Kremlin 2014-05-04” indicative of the date and the geo-location of where the cluster member photos were captured. The same applies mutatis mutandis to the remaining ones of the clusters (the second cluster 206, the third cluster 208, the fourth cluster 210, the fifth cluster 212, the sixth cluster 214, the seventh cluster 216 and the eighth cluster 218).

Within each of the one or more cluster members 222, the members of the cluster are identified by a respective object identifier, which can be a file name, an object identifier or the like. Using the example of the second cluster 206, the cluster title 220 associated with the second cluster 206 is “Moscow Red Square 2014-05-03” (also based on the metadata used for clustering) and the second cluster 206 has four members, which have been grouped into the second cluster 206 based on their metadata. More specifically, the second cluster 206 contains the following four members: <file 5 id>, <file 6 id>, <file 7 id> and <file 8 id>.

It should be noted that even though in the depiction of FIG. 2, the objects clustered into the eight clusters (the first cluster 204, the second cluster 206, the third cluster 208, the fourth cluster 210, the fifth cluster 212, the sixth cluster 214, the seventh cluster 216 and the eighth cluster 218) are associated with consecutively-numbered file names, this does not need to be so in every embodiments and was done for illustration purposes only.

It is worthwhile noting that organization of the photos associated with the User A into the clusters (the first cluster 204, the second cluster 206, the third cluster 208, the fourth cluster 210, the fifth cluster 212, the sixth cluster 214, the seventh cluster 216 and the eighth cluster 218) can be done based on a clustering policy maintained (and potentially changed, form time to time) by the remote storage server 116. For example, the clustering policy can prescribe which ones of the various metadata parameters are to be used for creating the clusters (for example, date only, geo-location only, resolution, application used to capture the photo, a combination of one or more of these or others metadata parameters or the like).

The remote storage server 116 can be configured to create the metadata mapping 202 and to transmit the metadata mapping 202 to the one or both of the first electronic device 102 and the second electronic device 104. The metadata mapping 202 is configured to enable the one or both of the first electronic device 102 and the second electronic device 104 to display to the user some or all of the objects (i.e. photos) organized into clusters. The remote storage server 116 can also be configured to transmit the objects themselves to the one or both of the first electronic device 102 and the second electronic device 104, which transmission can be together with the transmission of the metadata mapping 202 or separately.

The remote storage server 116 is also configured to re-organize the metadata mapping 202 based on either a clustering policy change or based on the user change that causes one or more of the clusters to change (or the members of the respective clusters to change).

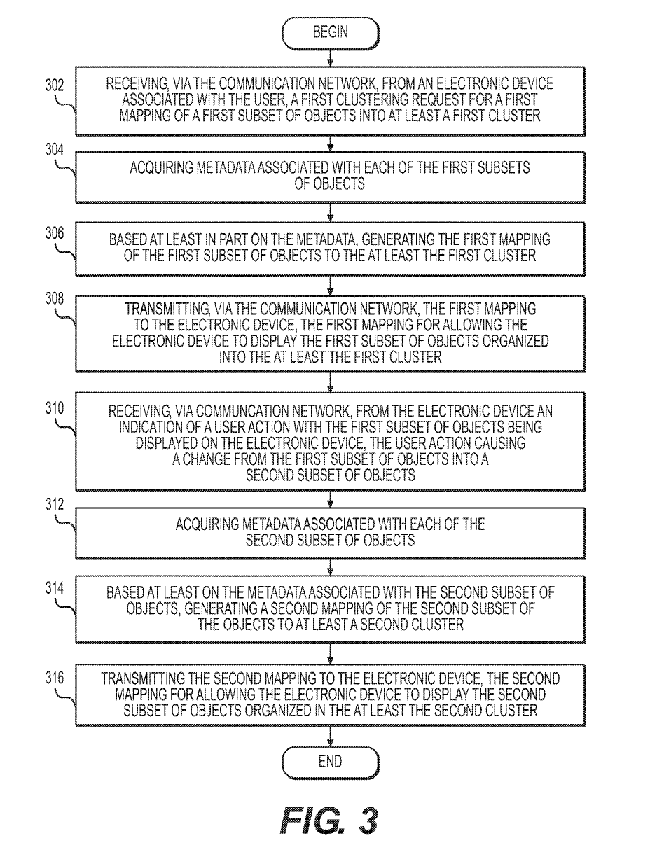

Given the architecture described above, it is possible to implement a method of organising objects stored, in association with a user, on the remote storage server 116. With reference to FIG. 3, there is depicted a flow-chart of a method 300, the method 300 being implemented in accordance with non-limiting embodiments of the present technology. The method 300 can be conveniently executed on the remote storage server 116.

Step 302—Receiving, via the Communication Network, from an Electronic Device Associated with the User, a First Clustering Request for a First Metadata Mapping of a First Subset of Objects into at least A First Cluster

The method 300 starts at step 302, where the remote storage server 116 receives, via the communication network, from an electronic device associated with the user, a first clustering request for a first metadata mapping of a first subset of objects into at least a first cluster.

Within some of the implementations of the present technology, the first metadata mapping request can be generated by one of the first electronic device 102 and the second electronic device 104. In some embodiments of the present technology, one of the first electronic device 102 and the second electronic device 104 generates the first clustering request in response to the user starting the photo application 108. Within these embodiments, the photo application 108 needs to receive mapping information to organize the photos into one or more clusters for displaying thereof to the user.

Alternatively, the first metadata mapping request can be generated by one of the first electronic device 102 and the second electronic device 104 in response to downloading the objects stored in the remote storage server 116 to the respective one (or both) of the first electronic device 102 and the second electronic device 104. In yet alternative embodiments, the first metadata mapping request can be generated by one of the first electronic device 102 and the second electronic device 104 (or by the remote storage server 116 itself) in response to the change in the clustering policy.

Step 304—Acquiring Metadata Associated with each of the First Subset of Objects

Next, at step 304, the remote storage server 116, acquires metadata associated with each of the first subset of objects.

The type of metadata acquired as part of step 304 will, naturally, depend on the type of objects being clustered. For example, in those embodiments where the objects comprise photo, the metadata can include at least one of: (i) an indication of a geo-location where the respective image was generated, (ii) an indication of a time when the respective image was generated; (iii) an indication of one or more individuals captured within the respective photos.

In alternative embodiments, where the objects comprise audio files, the metadata can include at least one of: (i) an indication of an artist associated with the audio track, (ii) an indication of a title associated with the audio file, (iii) an indication of an album associated with the audio track and (iv) a duration of the audio file.

In some embodiments, the remote storage server 116 acquires the metadata associated with the objects from the memory storage 182.

Step 306—Based at least in part on the Metadata, Generating the First Metadata Mapping of the First Subset of Objects to the at least the First Cluster

Next, at step 306, the remote storage server 116, based at least in part on the metadata, generates the first metadata mapping of the first subset of objects to the at least the first cluster.

More specifically, the remote storage server 116 generates the first metadata mapping, similar to the one depicted with reference to FIG. 2. In some embodiments of the present technology, the remote storage server 116 generates the metadata mapping based on a clustering policy. In the example depicted with reference to FIG. 2, the clustering policy is based on creating clusters based on geo-location and the capture date. As an example, the third cluster 208 is based on “Moscow Park” as the geo-location and “2014-05-04” as the capture date.

In some embodiments of the present technology, the remote storage server 116 is configured to store the first metadata mapping, as depicted in FIG. 2 with regard to the metadata mapping 202.

In some embodiments of the present technology, the remote storage server 116 can generate the first metadata mapping based on a clustering policy. Needless to say, the clustering policy can be based on a number of additional or different metadata parameters.

Step 308—Transmitting, via the Communication Network, the First Metadata Mapping to the Electronic Device, the First Metadata Mapping for Allowing the Electronic Device to Display The First Subset of Objects Organized into the at least the First Cluster

Next, at step 308, the remote storage server 116 transmits, via the communication network, the first metadata mapping to the electronic device, the first metadata mapping for allowing the electronic device to display the first subset of objects organized into the at least the first cluster.

In some embodiments of the present technology, the remote storage server 116 can also transmit the objects to be clustered either together with or separately from the first metadata mapping.

Step 310—Receiving, via Communication Network, from the Electronic Device an Indication of a User Action with the First Subset Of Objects Being Displayed on the Electronic Device, the User Action Causing a Change from the First Subset Of Objects into a Second Subset Of Objects

Next, at step 310, the remote storage server 116 receives, via communication network, from the electronic device an indication of a user action with the first subset of objects being displayed on the electronic device, the user action causing a change from the first subset of objects into a second subset of objects.

The indication of the user action can be generated by a number of events, the events being associated with user actions using the respective one of the first electronic device 102 and the second electronic device 104.

Some examples of the user actions include but are not limited to: deletion of an object from one of the clusters, adding a new object to one of the clusters, scrolling through the clusters and the like.

Step 312—Acquiring Metadata Associated with each of the Second Subset of Objects

Next, at step 312, the remote storage server 116 acquires metadata associated with each of the second subset of objects.

In some embodiments of the present technology, the remote storage server 116 acquires the metadata associated with all of the objects within the second subset of objects.

Alternatively, the remote storage server 116 can re-acquire metadata associated with only those of the second subset of objects that are different from the first subset of objects.

In some embodiments, the remote storage server 116 acquires the metadata associated with the objects of the second subset of objects from the memory storage 182.

Step 314—Based at least on the Metadata Associated with the Second Subset of Objects, Generating a Second Metadata Mapping of the Second Subset of the Objects to at least a Second Cluster

Next, at step 314, the remote storage server 116, based at least on the metadata associated with the second subset of objects, generates a second metadata mapping of the second subset of the objects to at least a second cluster.

More specifically, the remote storage server 116 generates the second metadata mapping, similar to the one depicted with reference to FIG. 2, taking into account the changes triggered by the user action, the indication of which was received as part of step 210.

In some embodiments of the present technology, the remote storage server 116 generates the metadata mapping based on the clustering policy. In some embodiments, the method 300 further includes checking if the clustering policy version has changed since the execution of step 306.

In some embodiments of the method 300, where the user action is deletion of an object from the first subset of objects to create the second sub-set of objects, the step of generating the second metadata mapping further comprises determining if any additional objects need to be added to the second sub-set of objects to create the second cluster. This can be the case, for example, when based on the user action, the number of objects associated with the changed cluster needs to be expanded and, as such, additional objects need to be added (moved) to the respective cluster.

The method 300 may further include determining if the at least one cluster need to be deleted. This may be the case when all the objects of the given cluster have been deleted or moved.

In some embodiments of the method 300, where the user action is an addition of a new object to the first subset of objects to create the second sub-set of objects, the method 300 further comprises determining if responsive to the addition of the new object, the first cluster needs to be re-organized into the second cluster and a third cluster, the second cluster and the third cluster being part of at least the second cluster. In some embodiments of the method 300, responsive to the determining rendering a positive outcome, the generating a second metadata mapping comprises: generating the second metadata mapping of a first portion of the second subset of the objects to the second cluster; and generating a third mapping of a second portion of the second subset of the objects to the second cluster.

In some embodiments of the method 300, where the user action is a scroll action, the first sub-set of objects can correspond to a paging resolution of the display of the electronic device, the step of generating a second metadata mapping comprises: based on the scroll action, determining an offset between the first subset of objects and the second subset of objects; and creating the second subset of objects organized in the at least the second cluster using the offset from a last object in the first sub-set.

In some embodiments of the method 300, the at least first cluster is a grouping of objects in a first period of time of creation of objects and the at least second cluster is a grouping of objects in a second period of time of creation of objects, and the user action is indicative of the user desire to switch from the first period to the second period; and the step of generating a second metadata mapping comprises: based on the user action, determining a time offset between the first period and the second period; and creating the second subset of objects organized in the at least the second cluster using the time offset from an end of the first period.

Step 316—Transmitting the Second Metadata Mapping to the Electronic Device, the Second Metadata Mapping for Allowing the Electronic Device to Display the Second Subset of Objects Organized in the at least the Second Cluster

Next, at step 316, the remote storage server 116, transmits the second metadata mapping to the electronic device, the second metadata mapping for allowing the electronic device to display the second subset of objects organized in the at least the second cluster.

The method 300 can then terminate or revert to execution of step 310 when an indication of another user action can be received.

In some embodiments of the method 300, where the electronic device is a wireless electronic device, such as the case with the second electronic device 104, the step of transmitting the second metadata mapping to the second electronic device 104 causes the second electronic device 104 to update the first metadata mapping with changes based on analysis of the second metadata mapping. In other words, upon receipt of the second metadata mapping, the second electronic device 104 can update the previously stored first metadata mapping with changes indicated by the second metadata mapping. As such, in some embodiments of the present technology, where the electronic device is executed as the wireless electronic device, the first metadata mapping can be downloaded when the second electronic device 104 accesses the remote storage server 116. At the same time, the second electronic device 104 can store an indication of the clustering policy version used to create the first metadata mapping. At a later point in time, when the second metadata mapping is transmitted to the second electronic device 104, the second metadata mapping can include an indication of the changes, based on the previous and current versions of the clustering policy.

In other embodiments of the method 300, where the electronic device is a stationary computing device, such as the case with the first electronic device 102, the step of transmitting the second metadata mapping to the electronic device causes the first electronic device 102 to replace the first metadata mapping with the second metadata mapping.

Naturally, it is possible to execute the steps of updating the first metadata mapping with the second metadata mapping differently. For example, even in case of the first electronic device 102, the first electronic device 102 can update the first metadata mapping with the changed cluster indicated by the second metadata mapping. Same applies to the second electronic device 104, where the second metadata mapping can simply replace the first metadata mapping.

In some embodiments of the method 300, the remote storage server 116 can transmit the second metadata mapping (and the first metadata mapping), to both the first electronic device 102 and the second electronic device 104. Hence, the transmission of the first metadata mapping and the second metadata mapping to both the first electronic device 102 and the second electronic device 104 enables both of the devices to respectively organize the objects into the first cluster and the second cluster. Notably, the organization of the objects into the second cluster is performed on both of the first electronic device 102 and the second electronic device 104, irrespective on which device the user action changing the first cluster to the second cluster was executed. In other words, embodiments of the method 300 allow for synchronization of the clustering between the first electronic device 102 and the second electronic device 104.

In some embodiments of the method 300, the step of transmitting, via the communication network, the first metadata mapping to the electronic device (i.e. the respective first electronic device 102 and the second electronic device 104) comprises transmitting an indication of each of the objects within the first subset of the objects.

In some embodiments of the method 300, the step of transmitting, via the communication network, the second metadata mapping to the electronic device (i.e. the respective first electronic device 102 and the second electronic device 104) comprises transmitting an indication of each of the objects within the second subset of the objects.

In other embodiments of the method 300, the step of transmitting, via the communication network, the second metadata mapping to the electronic device (i.e. the respective first electronic device 102 and the second electronic device 104) further comprises transmitting an indication of only those of the second subset that have changed compared to the first subset of objects.

In some embodiments of the present technology, the various routines described above can be implemented using Application Programming Interface (API). It is expected that those skilled in the art can implement the APIs given the description provided above. However, for the purposes of completion and an example, below are provided some of the example APIs that can be used for implementing embodiments of the present technology.

API for acquiring a list of periods:

```
/photohell/periods/list?uid=UID
{
  ‘version’: 1406279525506862,
  ‘list’: [
    { ‘year’: 2014, ‘list’: [
        { ‘month’: 1, ‘amount’: 10 },
        { ‘month’: 2, ‘amount’: 30 },
          ...
      ]},
    { ‘year’: 2013, ‘list’: [
      ...
    ]},
    ...
  ],
  ‘undefined’: 0,
}
```

API for acquiring a list of photos:

```
/photohell/photos/list?uid=UID&amount=AMOUNT&offset=
OFFSET&version=VERSION
{
  ‘version’: 1406279525506862,
  ‘total’: the size of received photos (can be different from AMOUNT)
  ‘list’: [
    { ‘cluster name/location/etc’: ‘somewhere 1’, ‘list’: [
      { file metadata },
      { file metadata },
      { file metadata },
      ...
    ] },
    { ‘cluster name/location/etc’: ‘somewhere 2’, ‘list’: [
      { file metadata },
      { file metadata },
      ...
    ] },
  ]
}
```

API for acquiring a full list of clusters and photos:

```
/photohell/photos/index?uid=UID
{
  ‘version’: 1406279525506862,
  ‘cluster_policy’: 4,
  ‘list’: [
    { ‘cluster name/location/etc’: ‘somewhere 1’, ‘list’: [
      { ‘id’: file_id_1, file metadata },
      { ‘id’: file_id_2, file metadata },
      { ‘id’: file_id_3, file metadata },
      ...
    ] },
    { ‘cluster name/location/etc’: ‘somewhere 2’, ‘list’: [
      { ‘id’: file_id_4, file metadata },
      { ‘id’: file_id_5, file metadata },
      ...
    ] },
  ]
}
```

API for acquiring changes in clusters and photos:

```
/photohell/photos/diff?uid=UID&version=
VERSION&cluster_policy=CLUSTER_POLICY
{
  ‘version’: 1406279525506869,
  ‘cluster_policy’: 4,
  ‘updated’: [
    { ‘cluster name/location/etc’: ‘somewhere 66’, ‘list’: [
      { ‘id’: file_id_134, file metadata },
      { ‘id’: file_id_12, file metadata },
      ...
    ] },
  ],
  ‘deleted’: [
    file_id_4 ,
    file_id_5
  ]
}
```

API for acquiring a state of the cluster based on an ID of a given photo:

```
/photohell/photos/changes?uid=UID&cluster_policy=
CLUSTER_POLICY&id=ID1,ID
2,...,ID
{
  ‘version’: 1406279525506869,
  ‘cluster_policy’: 4,
  ‘list’: [
    { ‘cluster name/location/etc’: ‘somewhere 66’, ‘list’: [
      { ‘id’: ID1, file metadata },
      { ‘id’: ID2, file metadata },
      ...
    ] },
  ]
}
```

One skilled in the art will appreciate when the instant description refers to “receiving data” from a user that the electronic device executing receiving of the data from the user may receive an electronic (or other) signal from the user. One skilled in the art will further appreciate that displaying data to the user via a user-graphical interface (such as the screen of the electronic device and the like) may involve transmitting a signal to the user-graphical interface, the signal containing data, which data can be manipulated and at least a portion of the data can be displayed to the user using the user-graphical interface.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of organising objects stored, in association with a user, on a server, the method executable on the server, the server being coupled to a communication network, the method comprising:
receiving, via the communication network, from an electronic device associated with the user, a first clustering request for a first metadata mapping of a first subset of objects into at least a first cluster;
acquiring metadata associated with each of the first subset of objects;
based at least in part on the metadata, generating the first metadata mapping of the first subset of objects to the at least the first cluster, the first metadata mapping not being in existence prior to said receiving;
transmitting, via the communication network, the first metadata mapping to the electronic device, the first metadata mapping for allowing the electronic device to display the first subset of objects organized into the at least the first cluster; said transmitting including not storing the first metadata mapping at the server after the transmitting to the electronic device;
receiving, via the communication network, from the electronic device an indication of a user action with the first subset of objects being displayed on the electronic device, the user action causing a change from the first subset of objects into a second subset of objects; the receiving further including receiving from the electronic device an indication of the first metadata mapping;
acquiring metadata associated with each of the second subset of objects;
based at least on the metadata associated with the second subset of objects and the first metadata mapping received from the electronic device, generating a second metadata mapping of the second subset of the objects to at least a second cluster, the second metadata mapping not being in existence prior to said receiving, and
transmitting the second metadata mapping to the electronic device, the second metadata mapping for allowing the electronic device to display the second subset of objects organized in the at least the second cluster, said transmitting including not storing the second metadata mapping at the server after the transmitting to the electronic device.

2. The method of claim 1, wherein the user action is deletion of an object from the first subset of objects to create the second sub-set of objects.

3. The method of claim 2, wherein the generating the second metadata mapping further comprises determining if any additional objects need to be added to the second sub-set of objects to create the second cluster.

4. The method of claim 2, wherein the generating the second metadata mapping further comprises determining if the at least one cluster need to be deleted.

5. The method of claim 1, wherein the user action is an addition of a new object to the first subset of objects to create the second sub-set of objects.

6. The method of claim 5, further comprising determining if responsive to the addition of the new object, the first cluster needs to be re-organized into the second cluster and a third cluster, the second cluster and the third cluster being part of at least the second cluster.

7. The method of claim 6, wherein responsive to the determining rendering a positive outcome, the generating a second metadata mapping comprises:
generating the second metadata mapping of a first portion of the second subset of the objects to the second cluster; and
generating a third mapping of a second portion of the second subset of the objects to the second cluster.

8. The method of claim 1, wherein the user action is a scroll action, wherein the first sub-set of objects corresponds to a paging resolution of the display of the electronic device, and wherein the generating a second metadata mapping comprises:
based on the scroll action, determining an offset between the first subset of objects and the second subset of objects; and
creating the second subset of objects organized in the at least the second cluster using the offset from a last object in the first sub-set.

9. The method of claim 1, wherein the at least first cluster is a grouping of objects in a first period of time of creation of objects and the at least second cluster is a grouping of objects in a second period of time of creation of objects, and wherein the user action is indicative of the user desire to switch from the first period to the second period; and wherein the generating a second metadata mapping comprises:
based on the user action, determining a time offset between the first period and the second period; and
creating the second subset of objects organized in the at least the second cluster using the time offset from an end of the first period.

10. The method of claim 1, wherein the objects comprise photos and wherein metadata includes at least one of: (i) an indication of a geo-location where the respective image was generated, (ii) an indication of a time when the respective image was generated; (iii) an indication of one or more individuals captured within the respective photos.

11. The method of claim 1, wherein the objects comprise audio files and wherein metadata includes at least one of: (i) an indication of an artist associated with the audio track, (ii) an indication of a title associated with the audio file, (iii) an indication of an album associated with the audio track and (iv) a duration of the audio file.

12. The method of claim 1, wherein the generating a second metadata mapping of the second subset of the objects to at least a second cluster further comprises analyzing metadata of all objects to create the second cluster.

13. The method of claim 1, wherein the electronic device is a wireless electronic device, and wherein the transmitting the second metadata mapping to the electronic device further causes the electronic device to update the first metadata mapping with changes based on analysis of the second metadata mapping.

14. The method of claim 1, wherein the electronic device is a stationary computing device, and wherein the transmitting the second metadata mapping to the electronic device further causes the electronic device to replace the first metadata mapping with the second metadata mapping.

15. The method of claim 1, wherein the electronic device is a first electronic device and wherein the transmitting, via the communication network, the first metadata mapping comprises transmitting the first metadata mapping to the first electronic device and a second electronic device, the first metadata mapping for allowing both the first electronic device and the second electronic device to display the first subset of objects organized into the at least the first cluster.

16. The method of claim 1, wherein the electronic device is a first electronic device and wherein the transmitting, via the communication network, the second metadata mapping comprises transmitting the second metadata mapping to the first electronic device and a second electronic device, the second metadata mapping for allowing both the first electronic device and the second electronic device to display the second subset of objects organized into the at least the second cluster.

17. The method of claim 1, wherein the transmitting, via the communication network, the first metadata mapping to the electronic device further comprises transmitting an indication of each of the objects within the first subset of the objects.

18. The method of claim 1, wherein the transmitting, via the communication network, the second metadata mapping to the electronic device further comprises transmitting an indication of each of the objects within the second subset of the objects.

19. The method of claim 1, wherein the transmitting, via the communication network, the second metadata mapping to the electronic device further comprises transmitting an indication of only those of the second subset that have changed compared to the first subset of objects.

20. A server comprising:
a communication interface for communication with an electronic device via a communication network,
a memory storage;
a processor operationally connected with the communication interface and the memory storage, the processor configured to store objects, in association with a user, on the memory storage, the processor being further configures to:
receive, via the communication interface, from an electronic device associated with the user, a first clustering request for a first metadata mapping of a first subset of objects into at least a first cluster;
acquire, from the memory storage, metadata associated with each of the first subset of objects;
based at least in part on the metadata, generate the first metadata mapping of the first subset of objects to the at least the first cluster, the first metadata mapping not being in existence prior to said receiving;
transmit, via the communication interface, the first metadata mapping to the electronic device, the first metadata mapping for allowing the electronic device to display the first subset of objects organized into the at least the first cluster; and not store the first metadata mapping at the server after the transmitting to the electronic device;
receive, via the communication interface, from the electronic device (i) an indication of a user action with the first subset of objects being displayed on the electronic device, the user action causing a change from the first subset of objects into a second subset of objects and (ii) an indication of the first metadata mapping;
acquire, from the memory storage, metadata associated with each of the second subset of objects;
based at least on the metadata associated with the second subset of objects and the first metadata mapping received from the electronic device, generate a second metadata mapping of the second subset of the objects to at least a second cluster, the second metadata mapping not being in existence prior to said receiving, and
transmit the second metadata mapping to the electronic device, the second metadata mapping for allowing the electronic device to display the second subset of objects organized in the at least the second cluster and not store the second metadata mapping at the server after the transmitting to the electronic device.

21.-38. (canceled)
